(19) United States
(12) Patent Application Publication
(10) Pub. No.: US 2006/0250043 A1
(43) Pub. Date: Nov. 9, 2006

(54) Portable handheld power generator

(76) Inventor: Wai Tat Chung, Hong Kong (CN)

Correspondence Address: Stephen B. Salai, Esq.;Harter, Secrest & Emery LLP, 1600 Bausch & Lomb Place, Rochester, NY, 14604-2711, US

(21) Appl. No.: 11/123,664

(22) Filed: May 6, 2005

(51) Int. Cl. H02K 7/18; H02K 11/00; H02K 21/12

(52) U.S. Cl. 310/216; 310/75 B; 310/156.12; 310/156.15; 290/1 R; 310/51

(57) ABSTRACT

A portable handheld electrical power generator for general consumption by household electronic devices is disclosed. The portable handheld power generator provides a magnet reinforcing ring and an armature core of stator lamination stamped with insulation film to provide improved performance and longer lasting operational life. The generator includes a generator casing; a cranking system, a set of cranking gears and an alternator comprised of a magnet-rotor base, a magnet reinforcing ring, a plurality of magnets, induction coils, armature core of stator lamination stamped with insulation film, all in a concentric manner and centered around an alternator drive shaft and housed within the generator casing. When a user manually drives the cranking handle, it causes the gear set to rotate which, in turn, brings about corresponding caming of the induction coils and the armature core, thereby generating electrical power for consumption.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “SEQUENCE LISTING”

Not Applicable.

### BACKGROUND OF THE INVENTION

### Field of the Invention

The present invention relates to a portable handheld power generator for ease of generating electrical power for general consumption by household electronic devices. The portable handheld power generator of the present invention provides a magnet reinforcing ring and an armature core of stator lamination stamped with insulation film to give rise to improved performance and longer lasting operational life.

Handheld power generators are not new. Prior patents which exemplify such devices include: GB 2371155; U.S. patent application Publication No. 2003/0184165 and U.S. Pat. No. 6,690,141. However, nearly all prior art handheld power generators enjoy a relatively short operational life due to the accelerated wear and tear of the alternator device resulted from constant driving and cranking movements.

The construction of an alternator typically used in a handheld power generator is not exceedingly complicated. It is usually comprised of a stator with cooper-winded induction coils on the armature teeth, a rotor or a casing to receive the stator and a plurality of magnets arranged in a ring-shaped configuration surrounding the stator. A shaft passing through the central axis of the stator, rotor and magnetic ring is used to connect to external driving mechanism in order to cam the alternator. Typically, one end of the shaft is operatively connected to the cranking gear of the generator device and the other end is disposed in a void to enable free caming movement of the shaft.

Constant and regular working of the alternator often causes the components, especially the magnet pieces to shift and dislocate, thus affecting the functioning of the generator device. In addition, while the stator is usually laminated, it cannot prevent the induction coil from becoming loose over time. Another shortcoming of the conventional stator lamination is that it often gives rise to a significant air gap for the magnetic flux to cross between the magnetic pole face and armature teeth. Consequently, after some extended period of use, the power generated from the generator diminishes rapidly, to the point that the generator could no longer function properly.

Accordingly, it is advantageous to provide a handheld power generator devoid of the shortcomings of the prior art devices.

### DESCRIPTION OF RELATED ART

FIG. 1 is a partially exploded view of the present invention.

FIG. 2A is an exploded view of the alternator of the present invention showing the magnet-rotor base on top.

FIG. 2B is an exploded view of the alternator of the present invention showing the magnet-rotor base on the bottom.

FIG. 3 is an enlarged drawing showing the orientation of the magnet reinforcing ring and the plurality of magnets of the present invention.

FIG. 4 is an enlarged drawing showing the insulation film of the present invention in relation to the induction coil and armature core.

FIG. 5 shows two perspective views of the casing and cranking handle of the present invention.

FIG. 6 shows the top, bottom, side, front and rear views of the casing and cranking handle of the present invention.

### BRIEF SUMMARY OF THE INVENTION

It is a primary object of the invention to provide a portable handheld power generator which enhances its performance.

Another object of the invention is to prolong the operational life of a portable handheld power generator.

These objects are realized in accordance with one aspect of the invention through the inclusion of a magnet reinforcing ring situated between the plurality of the ring-shaped magnets and the magnet-rotor base. Another aspect of the invention comprises stamping a layer of insulation film on the periphery of the stator laminations.

Accordingly, the invention provides for a portable handheld power generator for generating electrical power comprising, a generator casing; gear means housed within said generator casing; cranking means mounted on said generator casing and operatively connected to said gear means; an alternator comprised of a magnet-rotor base, a magnet reinforcing ring, a plurality of magnets, induction coils, armature core of stator lamination stamped with insulation film, all in a concentric manner and centred around an alternator drive shaft and housed within said generator casing and operatively positioned about the gear means for generating electrical power in response to rotating movement of said gear means caused by driving said cranking means; and electrical output connector means for channeling electrical power generated by said alternator for general power consumption.

The present invention also provides for a method for generating electrical power comprising driving a cranking means mounted to a portable handheld power generator casing, said cranking means is operatively connected to a gear means housed within said generator casing; rotating said gear means thereby causing an alternator to cam around an alternator shaft, said alternator being housed within said generator casing and operatively positioned about said gear means and comprising a magnet-rotor base, a magnet reinforcing ring, a plurality of magnets, induction coils, armature core of stator lamination stamped with insulation film, all in a concentric manner and centred around said alternator drive shaft; and channeling electrical power generated by said alternator to an electrical output connector means for general power consumption.

The various objects and advantages of the present invention will be more readily understood from the following detailed description when read in conjunction with the appended drawings.

### BRIEF DESCRIPTION OF THE SEVERAL VIEWS OF THE DRAWING(S)

Referring now to FIG. 1, there is illustrated a partially exploded view of a preferred embodiment of the portable handheld power generator of the present invention.

Reference numeral 100 represents the portable handheld power generator of the present invention. The generator 100 is consisted of four parts, namely a lightweight casing, a cranking means, a set of gears means and an alternator.

The lightweight casing is comprised of bottom cover 2 and top cover 4. A suitable space is provided inside the casing for housing the cranking gear set and the alternator. A conventional foldable cranking system is operationally mounted on the bottom cover 2 of the casing. The foldable cranking system is consisted of a cranking base 10 with its central axis aligned with and drivably connected to that of the primary starting gear 12 housed inside the generator casing such that cranking of the cranking base 10 translates the rotational movements to the primary starting gear 12. The cranking action is achieved rotating cranking base 10 by spring pressing the gear via the combined efforts of the gear being operated by clockwork spring and pushed by pendulum bob (not shown). A cranking handle 8 with a long ring attachment 6 which is secured by washer ring 32, screw 34 and screw cover 18, is hingedly mounted to the cranking base 10 by cranking pin 28. Such a foldable cranking system enables the user to conveniently fold the cranking handle 8 contiguous to the casing covers when the generator is not in use. A preferred embodiment also provides a recession on the casing covers for receiving the long ring attachment 6 extended from cranking handle 8.

As shown in FIG. 1, the cranking gear set is operationally connected to the alternator 200 and causes the alternator 200 to rotate when the gear set is cranked. Preferably, the gear set is comprised of a primary starting gear 12 and secondary differential gear 14. The central axis of the primary starting gear 12 is drivably connected to the foldable cranking system as described above. The outside gear teeth of the primary starting gear 12 engage to the driving teeth of the secondary differential gear 14. The rotational action of the primary starting gear 12 results in increased caming speed of the secondary differential gear 14. Since the outside teeth of the secondary differential gear 14 are operatively engaged to central axis and drive shaft 22 of the alternator, caming of the secondary differential gear 14 causes the induction coil 24 to rotate and generates electrical power. Optionally, white lubricant commonly used in the industry can be used to reduce friction in the drive shaft 22.

FIGS. 2A and 2B show two opposite exploded views of the alternator 200 of the present invention. FIG. 2A shows the magnet-rotor base 16 on top and FIG. 2B shows the magnet-rotor base 16 on the bottom. As illustrated, alternator 200 of the present invention differs from the conventional alternator in two major respects, namely (i) the inclusion of a magnet reinforcing ring 36 situated between the plurality of the ring-shaped magnets 20 and the magnet-rotor base 16; and (ii) the stamping of a layer of insulation film 38 on the periphery of the stator laminations comprising of induction coil 24 and armature core 42.

Magnet-rotor base 16 takes the shape of a circular casing. It can be made of plastic or any other suitable materials. Since the torque force will increase as the speed of the rotation of the induction coil 24 increases, the magnet-rotor 16 serves to reduce the torque force and to hold the position of the ring-shaped magnets 20 in place and, at the same time, to separate the magnets from one another. FIG. 3 is an enlarged drawing showing the orientation of the magnet reinforcing ring 36 and the plurality of magnets 20. The magnet reinforcing ring 36 is used to strengthen and to enhance the mechanical strength of the magnet-rotor base 16 by retaining the shape of base 16 in order to maintain the constant gap distance between the armature core 42 and the ring-shaped magnets 20, as well as to facilitate the positioning of the magnets 20 and to enhance the magnet flux.

FIG. 4 is an enlarged drawing showing the insulation film 38 in relation to the induction coil 24 and armature core 42. Armature core 42 is consisted of iron laminations which are insulated from one another and are assembled centred around the alternator drive shaft 22. It is well known that by laminating the armature core, electrical loss due to eddy-current is reduced. In an effort to accommodate and to enhance the mechanical stability of the armature core winding and to provide for a shorter gap for the magnetic flux crossing between the pole face and armature teeth, the present invention provides a layer of insulation film 38 which is stamped on the periphery of the iron lamination of the armature core 42 and the induction coil 24. Suitably, insulation film 38 is made of plastic or polyethylene.

Referring back to FIG. 1, the portable handheld power generator 100 of the present invention has an electrical output connector means for channeling electrical power generated by the alternator 200 for general power consumption. In the preferred embodiment as shown, an electrical output plug 30 is wiredly connected to the alternator 200 for users to plug in household electronic devices. Optionally, electrical output plug 30 can be replaced with three-pin wires connected by a 3PC connecting pin or cord. The 3PC pin enables the transfer of low voltage AC current (e.g., 1.2V to 9.6V) to other detachable devices, such as rechargeable batteries, via a full-wave rectification circuit and control circuit (i.e., PCBA). By replacing the output plug 30 with a 3PC connecting pin, the users may charge multiple accessories simultaneously.

It is clear that the inventive concept of this portable handheld generator is not limited to the specific design of the particular embodiment disclosed herein. Any conventional portable handheld generator can incorporate the present inventive concept by including a magnet reinforcing ring to strengthen the magnet-rotor base and by stamping a layer of insulation film on the periphery of the stator laminations. Thus, the embodiments depicted herein are intended to be merely illustrative and not restrictive in any sense.

It is further understood that the present invention may be carried out in other specific way than those herein set forth without departing from the spirit and essential characteristics of such invention. The present embodiments are, therefore, to be considered in all respects as illustrative and not restrictive, and all changes coming within the meaning and equivalency range of the appended claims are intended to be embraced therein.

### DETAILED DESCRIPTION OF THE INVENTION

Referring now to FIG. 1, there is illustrated a partially exploded view of a preferred embodiment of the portable handheld power generator of the present invention.

Reference numeral 100 represents the portable handheld power generator of the present invention. The generator 100 is consisted of four parts, namely a lightweight casing, a cranking means, a set of gears means and an alternator.

The lightweight casing is comprised of bottom cover 2 and top cover 4. A suitable space is provided inside the casing for housing the cranking gear set and the alternator. A conventional foldable cranking system is operationally mounted on the bottom cover 2 of the casing. The foldable cranking system is consisted of a cranking base 10 with its central axis aligned with and drivably connected to that of the primary starting gear 12 housed inside the generator casing such that cranking of the cranking base 10 translates the rotational movements to the primary starting gear 12. The cranking action is achieved rotating cranking base 10 by spring pressing the gear via the combined efforts of the gear being operated by clockwork spring and pushed by pendulum bob (not shown). A cranking handle 8 with a long ring attachment 6 which is secured by washer ring 32, screw 34 and screw cover 18, is hingedly mounted to the cranking base 10 by cranking pin 28. Such a foldable cranking system enables the user to conveniently fold the cranking handle 8 contiguous to the casing covers when the generator is not in use. A preferred embodiment also provides a recession on the casing covers for receiving the long ring attachment 6 extended from cranking handle 8.

As shown in FIG. 1, the cranking gear set is operationally connected to the alternator 200 and causes the alternator 200 to rotate when the gear set is cranked. Preferably, the gear set is comprised of a primary starting gear 12 and secondary differential gear 14. The central axis of the primary starting gear 12 is drivably connected to the foldable cranking system as described above. The outside gear teeth of the primary starting gear 12 engage to the driving teeth of the secondary differential gear 14. The rotational action of the primary starting gear 12 results in increased caming speed of the secondary differential gear 14. Since the outside teeth of the secondary differential gear 14 are operatively engaged to central axis and drive shaft 22 of the alternator, caming of the secondary differential gear 14 causes the induction coil 24 to rotate and generates electrical power. Optionally, white lubricant commonly used in the industry can be used to reduce friction in the drive shaft 22.

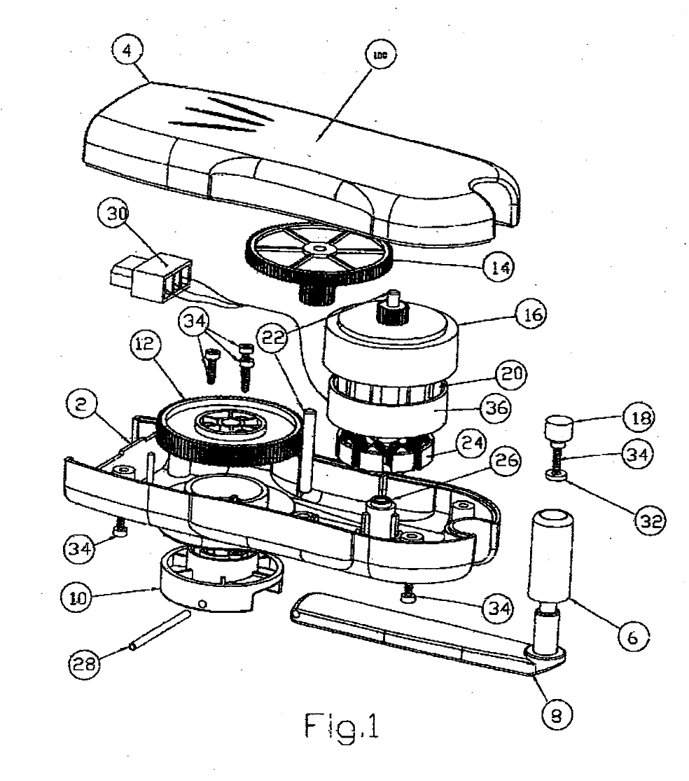

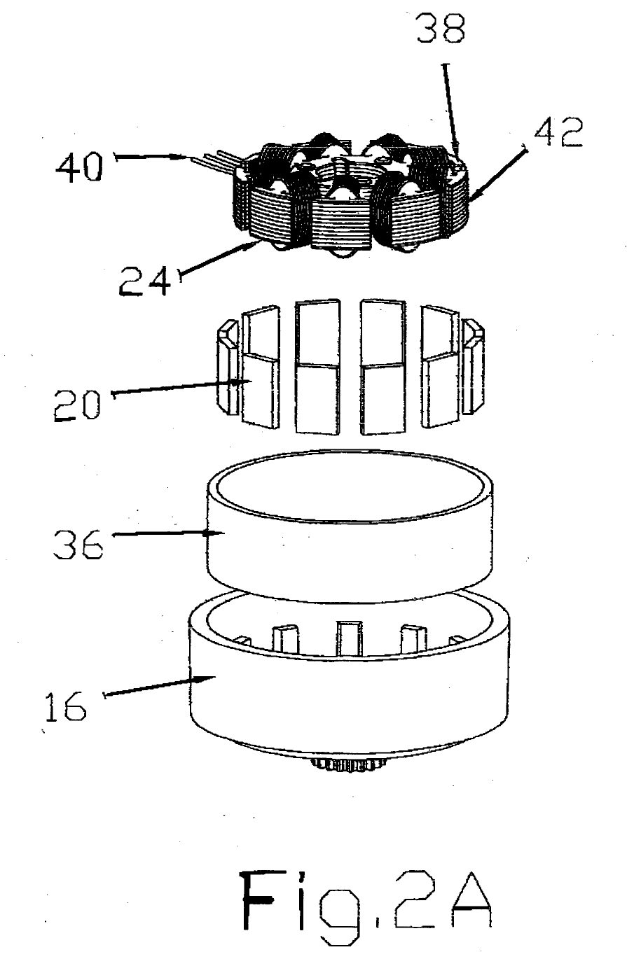

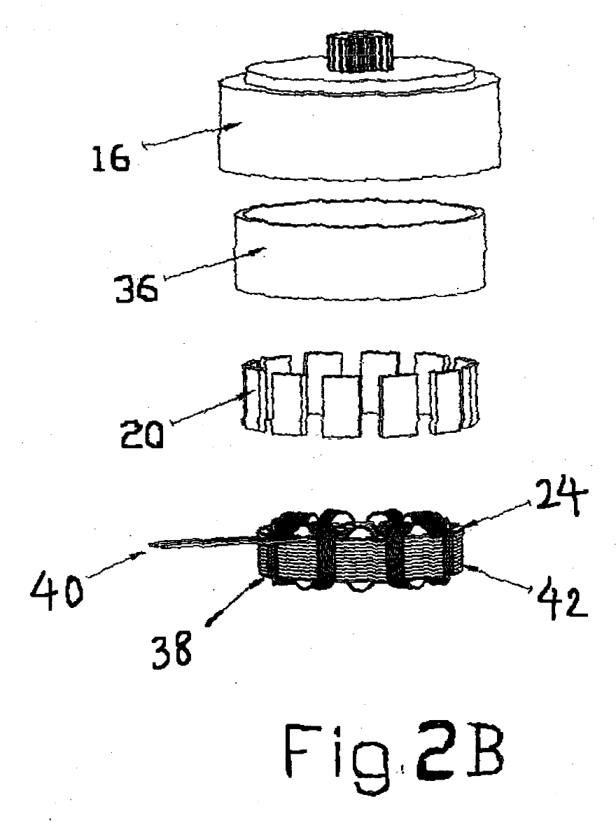

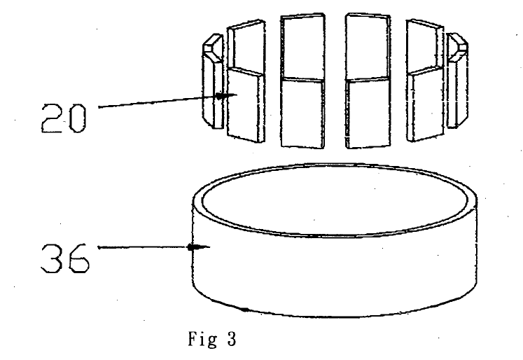

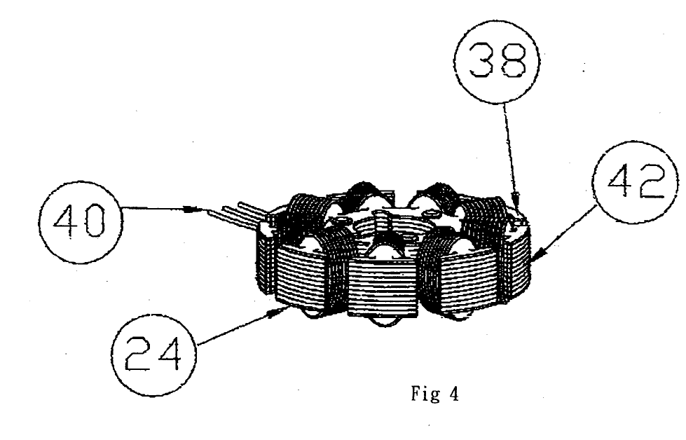

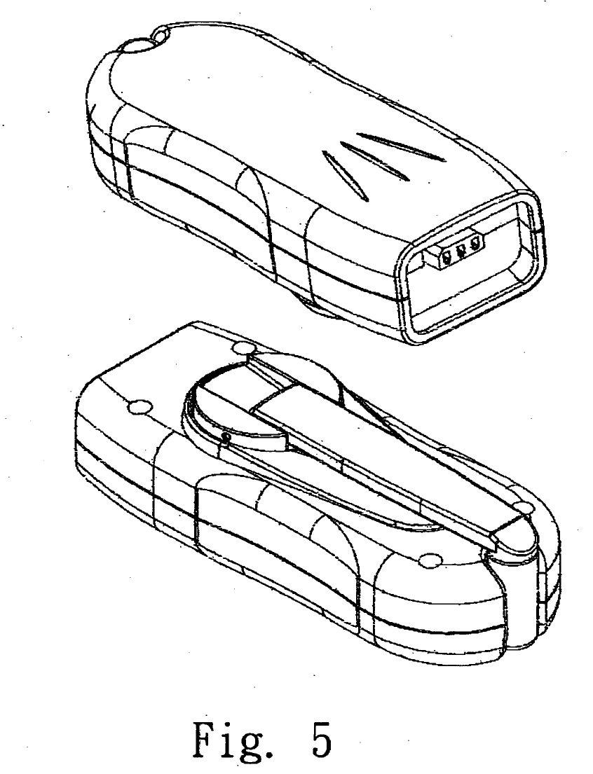

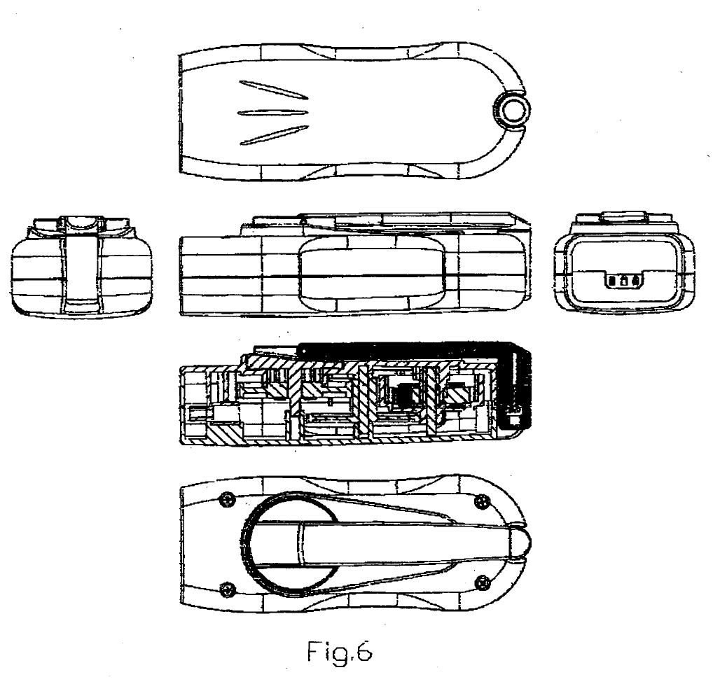

FIGS. 2A and 2B show two opposite exploded views of the alternator 200 of the present invention. FIG. 2A shows the magnet-rotor base 16 on top and FIG. 2B shows the magnet-rotor base 16 on the bottom. As illustrated, alternator 200 of the present invention differs from the conventional alternator in two major respects, namely (i) the inclusion of a magnet reinforcing ring 36 situated between the plurality of the ring-shaped magnets 20 and the magnet-rotor base 16; and (ii) the stamping of a layer of insulation film 38 on the periphery of the stator laminations comprising of induction coil 24 and armature core 42.

Magnet-rotor base 16 takes the shape of a circular casing. It can be made of plastic or any other suitable materials. Since the torque force will increase as the speed of the rotation of the induction coil 24 increases, the magnet-rotor 16 serves to reduce the torque force and to hold the position of the ring-shaped magnets 20 in place and, at the same time, to separate the magnets from one another. FIG. 3 is an enlarged drawing showing the orientation of the magnet reinforcing ring 36 and the plurality of magnets 20. The magnet reinforcing ring 36 is used to strengthen and to enhance the mechanical strength of the magnet-rotor base 16 by retaining the shape of base 16 in order to maintain the constant gap distance between the armature core 42 and the ring-shaped magnets 20, as well as to facilitate the positioning of the magnets 20 and to enhance the magnet flux.

FIG. 4 is an enlarged drawing showing the insulation film 38 in relation to the induction coil 24 and armature core 42. Armature core 42 is consisted of iron laminations which are insulated from one another and are assembled centred around the alternator drive shaft 22. It is well known that by laminating the armature core, electrical loss due to eddy-current is reduced. In an effort to accommodate and to enhance the mechanical stability of the armature core winding and to provide for a shorter gap for the magnetic flux crossing between the pole face and armature teeth, the present invention provides a layer of insulation film 38 which is stamped on the periphery of the iron lamination of the armature core 42 and the induction coil 24. Suitably, insulation film 38 is made of plastic or polyethylene.

Referring back to FIG. 1, the portable handheld power generator 100 of the present invention has an electrical output connector means for channeling electrical power generated by the alternator 200 for general power consumption. In the preferred embodiment as shown, an electrical output plug 30 is wiredly connected to the alternator 200 for users to plug in household electronic devices. Optionally, electrical output plug 30 can be replaced with three-pin wires connected by a 3PC connecting pin or cord. The 3PC pin enables the transfer of low voltage AC current (e.g., 1.2V to 9.6V) to other detachable devices, such as rechargeable batteries, via a full-wave rectification circuit and control circuit (i.e., PCBA). By replacing the output plug 30 with a 3PC connecting pin, the users may charge multiple accessories simultaneously.

It is clear that the inventive concept of this portable handheld generator is not limited to the specific design of the particular embodiment disclosed herein. Any conventional portable handheld generator can incorporate the present inventive concept by including a magnet reinforcing ring to strengthen the magnet-rotor base and by stamping a layer of insulation film on the periphery of the stator laminations. Thus, the embodiments depicted herein are intended to be merely illustrative and not restrictive in any sense.

It is further understood that the present invention may be carried out in other specific way than those herein set forth without departing from the spirit and essential characteristics of such invention. The present embodiments are, therefore, to be considered in all respects as illustrative and not restrictive, and all changes coming within the meaning and equivalency range of the appended claims are intended to be embraced therein.

1. A portable handheld power generator for generating electrical power comprising,
(a) a generator casing;
(b) gear means housed within said generator casing;
(c) cranking means mounted on said generator casing and operatively connected to said gear means;
(d) an alternator comprised of a magnet-rotor base, a magnet reinforcing ring, a plurality of magnets, induction coils, armature core of stator lamination stamped with insulation film, all in a concentric manner and centred around an alternator drive shaft and housed within said generator casing and operatively positioned about the gear means for generating electrical power in response to rotating movement of said gear means caused by driving said cranking means; and
(e) electrical output connector means for channeling electrical power generated by said alternator for general power consumption.

2. The portable handheld power generator of claim 1, wherein said gear means is comprised of a primary gear and one or more secondary gear, whereby the rotating movement of the cranking means causes the primary gear to increase the gear ratio of the secondary gear to drive up the rotating speed of said alternator.

3. The portable handheld power generator of claim 1, wherein said insulation film is made of plastic or polyethylene.

4. The portable handheld power generator of claim 1, wherein said magnet reinforcing ring is made of metal.

5. The portable handheld power generator of claim 1, wherein said electrical output connector means is comprised of three-pin wires connected by a 3PC connecting pin or cord.

6. A method for generating electrical power comprising:
(a) driving a cranking means mounted to a portable handheld power generator casing, said cranking means is operatively connected to a gear means housed within said generator casing;
(b) rotating said gear means thereby causing an alternator to cam around an alternator shaft, said alternator being housed within said generator casing and operatively positioned about said gear means and comprising a magnet-rotor base, a magnet reinforcing ring, a plurality of magnets, induction coils, armature core of stator lamination stamped with insulation film, all in a concentric manner and centred around said alternator drive shaft; and
(c) channeling electrical power generated by said alternator to an electrical output connector means for general power consumption.

7. The method of claim 6, wherein said gear means is comprised of a primary gear and one or more secondary gear, whereby the rotating movement of the cranking means causes the primary gear to increase the gear ratio of the secondary gear to drive up the rotating speed of said alternator.

8. The method of claim 6, wherein said insulation film is made of plastic or polyethylene.

9. The method of claim 6, wherein said magnet reinforcing ring is made of metal.

10. The method of claim 6, wherein said electrical output connector means is comprised of three-pin wires connected by a 3PC connecting pin or cord.
